(19) United States
(12) Patent Application Publication
(10) Pub. No.: US 2013/0050164 A1
(43) Pub. Date: Feb. 28, 2013

(54) ELECTRONIC DEVICE CASES AND COVERS HAVING A REFLECTIVE DISPLAY, AND METHODS THEREOF

(71) Applicant: Nicholaus R. Rericha, Norwood, OH (US)

(72) Inventor: Nicholaus R. Rericha, Norwood, OH (US)

(21) Appl. No.: 13/592,962

(22) Filed: Aug. 23, 2012

Related U.S. Application Data
(60) Provisional application No. 61/526,328, filed on Aug. 23, 2011.

(51) Int. Cl. G09G 5/00

(52) U.S. Cl. 345/205

(57) ABSTRACT

Electronic device cases and covers having one or more reflective displays are disclosed. In one embodiment, an electronic device case for coupling to an electronic device having an illuminated display includes a case body configured to surround two or more edges of the electronic device, and a reflective display within the case body. The reflective display is positioned on a surface of the electronic device that is opposite from the illuminated display of the electronic device when the electronic device case is coupled to the electronic device. The electronic device case further includes a reflective display driver within the case body for controlling the reflective display. The reflective display driver is electrically coupled to the reflective display, receives display data from the electronic device, and controls the reflective display to display the display content corresponding to the display data.

### CROSS-REFERENCE TO RELATED APPLICATIONS

The present application claims priority to U.S. Patent Application Ser. No. 61/526,328 entitled “Electronic Device Cases Having an Electronic Paper Display” Electronic Device Cases and Covers Having Electronic Paper Display, and Methods Thereof” filed on Aug. 23, 2011, which is hereby incorporated by reference in its entirety.

### BACKGROUND

1. Field

The present disclosure is directed to electronic device cases and covers used to cover and protect mobile electronic devices and, more particularly, electronic device cases and covers having a reflective display to provide a dual-display device.

2. Technical Background

Mobile electronic devices, such as smart phones, music players, tablet computers, and the like, typically include a liquid crystal display (LCD) for presenting display content to a user. Such devices may also include displays of other technology, such as organic light emitting diode (OLED), active matrix OLED (AMOLED) and the like. These display technologies are non-reflective, meaning that they emit light for displaying images either by a backlighting illumination source (e.g., light emitting diodes (LED) or fluorescent light sources in the case of LCD displays) or by the pixels of the display (in the case of OLED and AMOLED displays). However, the active lighting of non-reflective (illuminated) display devices has been known to cause eye strain for many users, especially when the user views the illuminated display screen for long periods of time.

E-book readers using reflective displays, such as electronic paper (“e-paper”), are an alternative to illuminated display devices. E-paper displays use bi-stable display technology such as electrophoretic, electrofluidic, cholesteric liquid crystal, and the like to present a display that does not back lighting. These displays use ambient light that reflects off the display surface to present images to the user, and are viewable much like regular paper. Such displays consume much less power than a backlit LCD display or other illuminated display technologies such as LED, OMLED, and AMOLED. It has been reported that users may comfortably view electronic devices having reflective displays for long periods of time.

However, consumers currently must choose between which devices to purchase. A person having a smart phone or computer tablet may also wish to have an e-book reader for long-duration reading sessions. He or she must, therefore, carry two devices (one with illuminated screen and one with a reflective, e-paper based e-book reader).

### SUMMARY

According to one embodiment, an electronic device case for coupling to an electronic device having an illuminated display includes a case body configured to surround two or more edges of the electronic device, and a reflective display within the case body. The reflective display is capable of displaying display content and is positioned on a surface of the electronic device that is opposite from the illuminated display of the electronic device when the electronic device case is coupled to the electronic device. The electronic device case further includes a reflective display driver within the case body for controlling the reflective display. The reflective display driver is electrically coupled to the reflective display and is configured to be communicatively coupled to the electronic device. The reflective display driver receives display data from the electronic device, and controls the reflective display to present the display content corresponding to the display data.

According to another embodiment, an electronic device case for coupling to an electronic device includes a case body configured to surround at least two edges of the electronic device, a hinge portion at the side wall of the case body, a cover flap, a reflective display, and a reflective display driver. The cover flap is coupled to the hinge portion, and is operable to pivot about an axis defined by the hinge portion to transition between a covered position such that the cover flap substantially covers the illuminated display of the electronic device, and an uncovered position such that the cover flap does not cover the illuminated display of the electronic device. The reflective display is disposed within the cover flap, and is capable of displaying display content. The reflective display is within the cover flap or the case body, is electrically coupled to the reflective display, and is configured to be communicatively coupled to the electronic device. The reflective display driver receives display data corresponding to an image for display on the illuminated display of the electronic device from the electronic device, and controls the reflective display to display the display content corresponding to the display data.

According to yet another embodiment, a method of displaying an image on an electronic device case that is coupled to an electronic device, the electronic device case having a reflective display and the electronic device comprising an illuminated display, includes receiving a user input from the electronic device, wherein the user input corresponds to an instruction to display display content on the reflective display. The method further includes receiving display data corresponding to the display content from the electronic device, and displaying the display content on the reflective display. The method may further include disabling the illuminated display of the electronic device in response to receipt of the user input. The method may also include receiving a second user input signal via the electronic device case, the second user input signal corresponding to a request to display a second image on the reflective display, providing a second data signal from the electronic device to the reflective display, wherein the second data signal corresponds to display data associated with the second image, and displaying the second image on the reflective display. The method may also include receiving a second user input signal via the electronic device case, the second user input signal corresponding to a request to resume use of the illuminated display of the electronic device, providing a second data signal from the electronic device to the reflective display, wherein the second data signal corresponds to display data associated with inactive display content, and turning on the illuminated display of the electronic device.

### BRIEF DESCRIPTION OF THE DRAWINGS

The components of the following figures are illustrated to emphasize the general principles of the present disclosure and are not necessarily drawn to scale. The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 is a schematic illustration of a rear, perspective view of an exemplary electronic device case, according to one or more embodiments shown and described herein;

FIG. 2 is a schematic illustration of a rear view of the exemplary electronic device case illustrated in FIG. 1, according to one or more embodiments shown and described herein;

FIG. 3 is a schematic illustration of a front view of the exemplary electronic device case illustrated in FIG. 1 coupled to an electronic device, according to one or more embodiments shown and described herein;

FIG. 4 is a schematic illustration of a front, perspective view of the exemplary electronic device case illustrated in FIG. 1 without an electronic device, according to one or more embodiments shown and described herein;

FIG. 5 is a schematic illustration of a cross-sectional view of the exemplary electronic device case illustrated in FIG. 4 taken along line 5-5, according to one or more embodiments shown and described herein;

FIG. 6 is a schematic illustration of a side view of the exemplary electronic device case illustrated in FIG. 1 with a control portion in a closed position, according to one or more embodiments shown and described herein;

FIG. 7 is a schematic illustration of the side view of the exemplary electronic device case illustrated in FIG. 6 with a control portion in an opened position, according to one or more embodiments shown and described herein;

FIG. 8 is a cross-sectional view of a reflective display portion of an electronic device case, according to one or more embodiments shown and described herein;

FIG. 9 is a schematic illustration of internal components of an exemplary electronic device case, according to one or more embodiments shown and described herein;

FIG. 10 is a front, perspective view of an exemplary electronic device case, according to one or more embodiments shown and described herein;

FIG. 11 is a rear view of the exemplary electronic device case illustrated in FIG. 10, according to one or more embodiments shown and described herein;

FIG. 12 is a front view of the exemplary electronic device case illustrated in FIG. 10 coupled to an electronic device, according to one or more embodiments shown and described herein;

FIG. 13 is a rear, perspective view of an exemplary electronic device case, according to one or more embodiments shown and described herein;

FIG. 14 is a front, perspective view of an exemplary electronic device case in a partially opened position, according to one or more embodiments shown and described herein;

FIG. 15 is a front, perspective view of the exemplary electronic device case in a closed position, according to one or more embodiments shown and described herein;

FIG. 16 is a perspective view of an exemplary electronic device case coupled to an electronic device and having a cover flap, according to one or more embodiments shown and described herein;

FIG. 17 is a front view of the exemplary electronic device case illustrated in FIG. 16 with the cover flap in a closed position, according to one or more embodiments shown and described herein;

FIG. 18 is a perspective view of an exemplary electronic device case coupled to an electronic device and having an inner cover flap and an outer cover flap, according to one or more embodiments shown and described herein;

FIG. 19 is a front view of an exemplary electronic device cover coupled to an electronic device, according to one or more embodiments shown and described herein;

FIG. 20 is a front view of the exemplary electronic device cover illustrated in FIG. 19 being coupled to an electronic device, according to one or more embodiments shown and described herein; and

FIG. 21 is a top, perspective view of the exemplary electronic device cover coupled to the electronic device illustrated in FIG. 19, wherein the electronic device cover is in partially opened position, according to one or more embodiments shown and described herein.

### DETAILED DESCRIPTION

Reference is now made in detail to the preferred embodiments of the disclosure, examples of which are illustrated in the accompanying drawings. Whenever possible, like reference numbers are used to refer to like components or parts.

Embodiments of the present disclosure are directed to electronic device cases and covers that incorporate a reflective display, such as an electronic paper (“e-paper”) display, and are capable of being physically and electrically coupled to electronic devices. Embodiments described herein enable an electronic device (e.g., smart phone, media player, tablet computer, and the like) having a illuminated screen to also have a removable reflective display on the electronic device. As used herein, “reflective display” means a display device that presents information by reflecting light off its surface, rather than emitting light to present information. Examples of reflective display technology include, but are not limited to, electronic paper technologies such as electrophoretic displays, electrowetting displays, electrofluidic displays, and cholesteric liquid crystal displays. The phrases “reflective display” and “e-paper display” are used interchangeably herein.

As used herein, “non-reflective display” means a display device that emits light to present information, either by backlighting, by emitting light directly from the pixels of the display, or other lighting means. Examples of non-reflective display include, but are not limited to, backlit liquid crystal display (LCD) displays, light emitting diode (LED) displays, organic light emitting diode (OLED) displays, and active-matrix organic light emitting diode (AMOLED) displays.

The embodiments described herein may be physically and electrically coupled to an electronic device to receive display data corresponding to visual information received from the electronic device. The non-reflective display of the electronic device to which the electronic device case or cover is coupled may be selectively turned off, and the e-paper display of the electronic device cover or case may be selectively turned on so that the user may selectively view the e-paper display. Embodiments therefore allow an electronic device having a display that emits light to also function as an e-book reader having an e-paper display.

As an example and not a limitation, a user of an electronic device case coupled to an electronic device having a non-reflective display may decide to read an electronic book (“e-book”) stored on the electronic device. The user may selectively turn off the main non-reflective display screen of the electronic device and turn on the e-paper display of the electronic device case to enjoy reading the e-book without the eye strain that may be caused by the emission of light from the electronic device. Conveniently, the user does not need to carry two separate devices. Further, embodiments protect the electronic device even when not being used for display purposes. Various embodiments of the electronic device cases and covers, as well as methods of displaying display content on an electronic device case, are described in detail below.

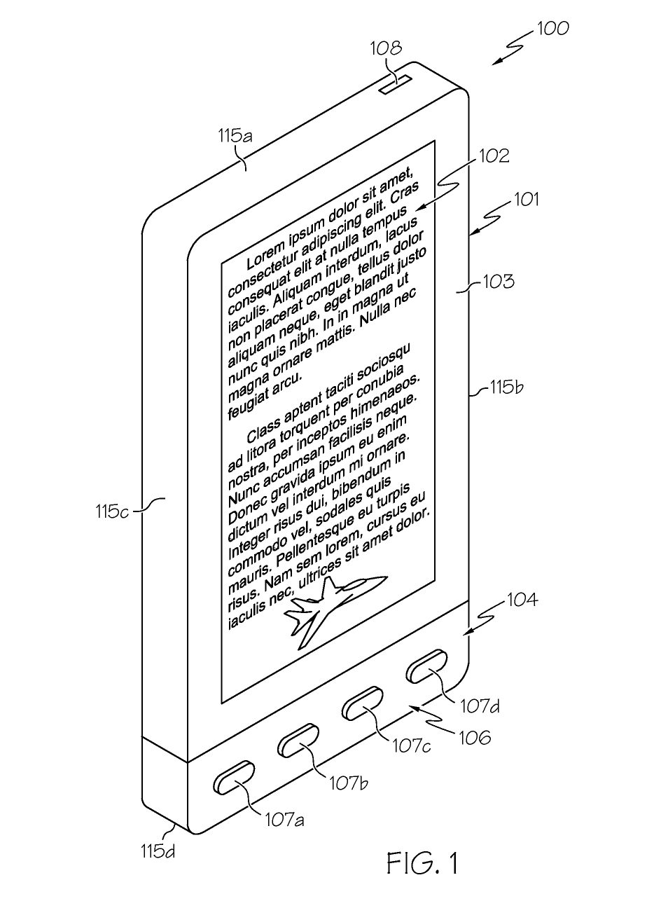

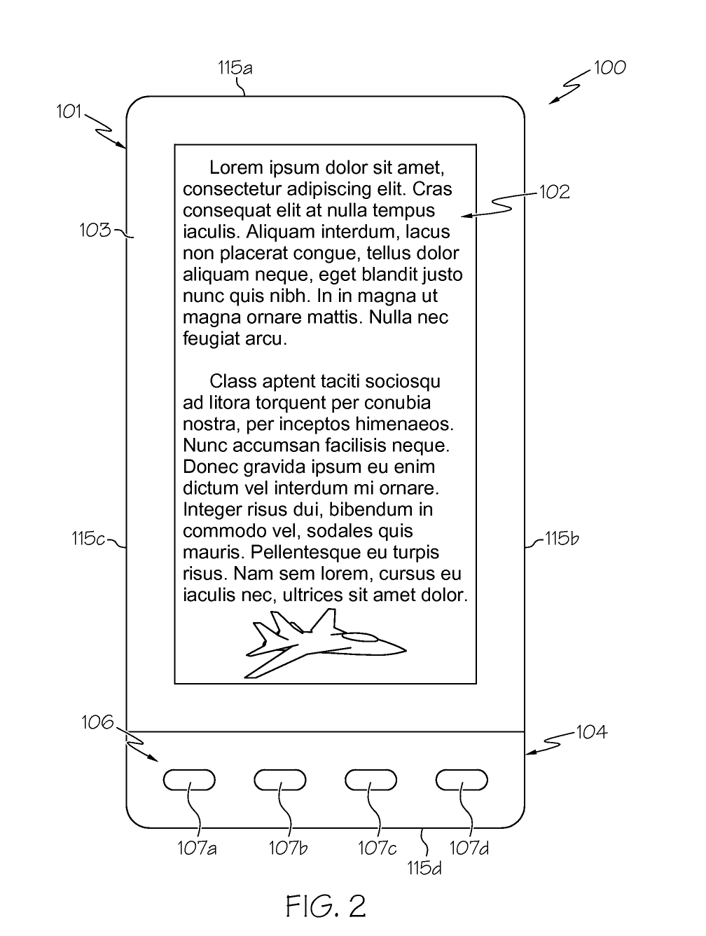

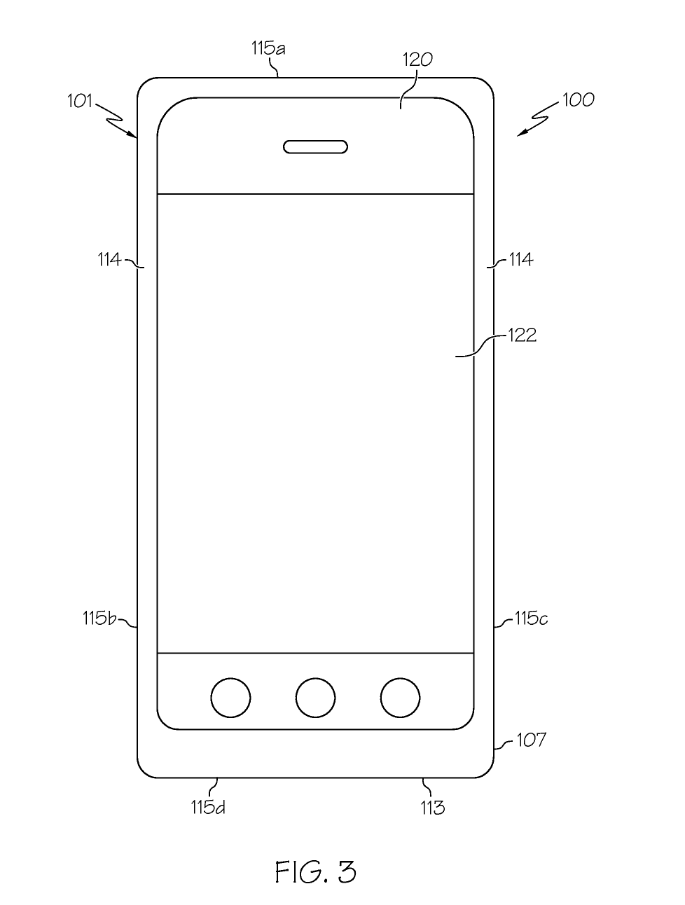

Referring to FIGS. 1-3, an electronic device case 100 is shown physically coupled to an electronic device 120. FIG. 1 is a rear, perspective view of the electronic device with the electronic device coupled thereto. Accordingly, FIG. 1 depicts a front display surface of the electronic device case 100. FIG. 2 is a front elevation view of the electronic device 120, while FIG. 3 is a front elevation view of the electronic device 120 (i.e., a rear elevation view of the electronic device case 100).

The electronic device 120 may be a device having a non-reflective display 122, such as an LCD display or other backlit or otherwise illuminated display. For example, the electronic device 120 may be a smart phone, a media player, a personal digital assistant, a tablet computer or the like.

The electronic device case 100 generally comprises a case body 101 that is configured to be removably coupled to the electronic device 120. The case body 101 generally includes a rear surface 103 and a plurality of side walls 115a-115d that may surround a plurality of edges of the electronic device 120. One or more of the side walls 115a-115d may include a button feature 108 that is configured to contact a button of the electronic device 120 (e.g., an on/off button).

As described in more detail below, the case body 101 may include engagement features 114 that enable the electronic device case 100 to be removably coupled to the electronic device 120. In some embodiments, the case body 101 may be fabricated from a pliable material, such as silicone, leather, or polyimide materials, for example, so that the case body 101 may be stretched and conformed to the shape of the electronic device 120 to which it is coupled. In other embodiments, the case body 101 may be fabricated from a more rigid material, such as rigid plastic. The case body 101 is configured to protect the electronic device 120 from inadvertent drops, contact with sharp objects (e.g., keys), and other damage-causing situations.

The electronic device 120 further comprises a reflective display 102 within the rear surface 103 of the case body 101. As shown in FIGS. 1-3, the reflective display 102 is present on a backside of the electronic device 120 when the electronic device case 100 is coupled to the electronic device 120. The reflective display 102 may be configured as any type of display that does not require backlighting to be viewable by a user. Reflective displays, such as e-paper displays, may include, but are not limited to, electrophoretic, electrofluidic, and cholesteric liquid crystal. As described in more detail below, the reflective display 102 may be a flexible display for use in an electronic display case 100 that is pliable, or a rigid display for use in a rigid electronic display case 100. The reflective display 102 comprises a display layer comprising an array of pixels that is mounted flexible substrate, thereby allowing the reflective display 102 to be bent and used as an electronic device case. The reflective display 102 may be molded into the material of the electronic device case 100 such that it is viewable to the user. Further, as described in more detail below, the reflective display 102 may further include an anti-scratch coating or layer to prevent the reflective display 102 from scratches. When coupled to an electronic device 120, the reflective display 102 is positioned on a backside of the electronic device 120 such that the reflective display 102 is on a surface of the electronic device that is opposite from the illuminated display 122.

The electronic device case 100 is communicatively coupled to the electronic device 120 by one or more communication modules so that data may be exchanged between the electronic display case 100 and the electronic device 120 (i.e., bidirectional communication). For example, display data corresponding to display content that the user desires may be stored on the electronic device 120. The display data may be provided from the electronic device 120 to the electronic device case 100 for display on the reflective display 102. In this manner, the electronic device 120 acts as a host device for the electronic device case 100.

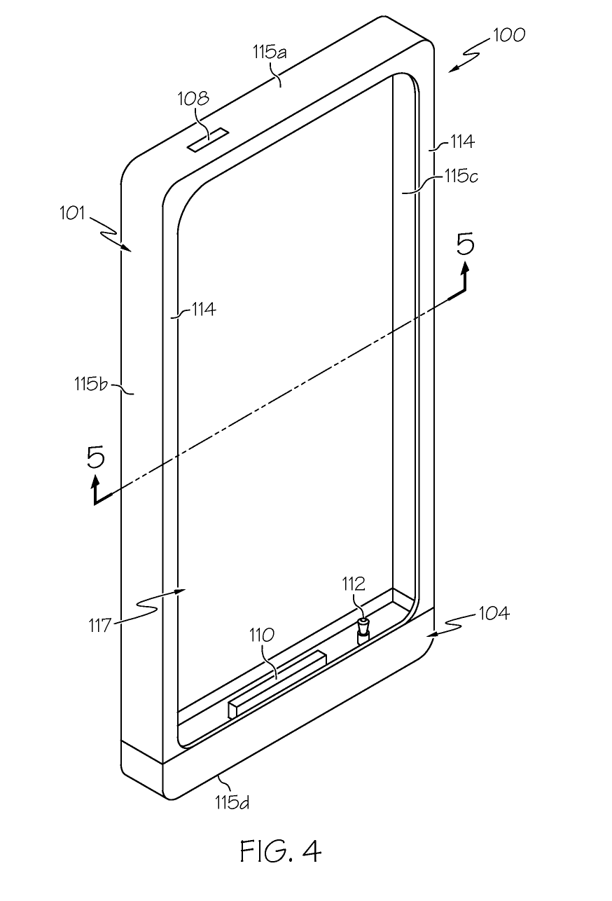

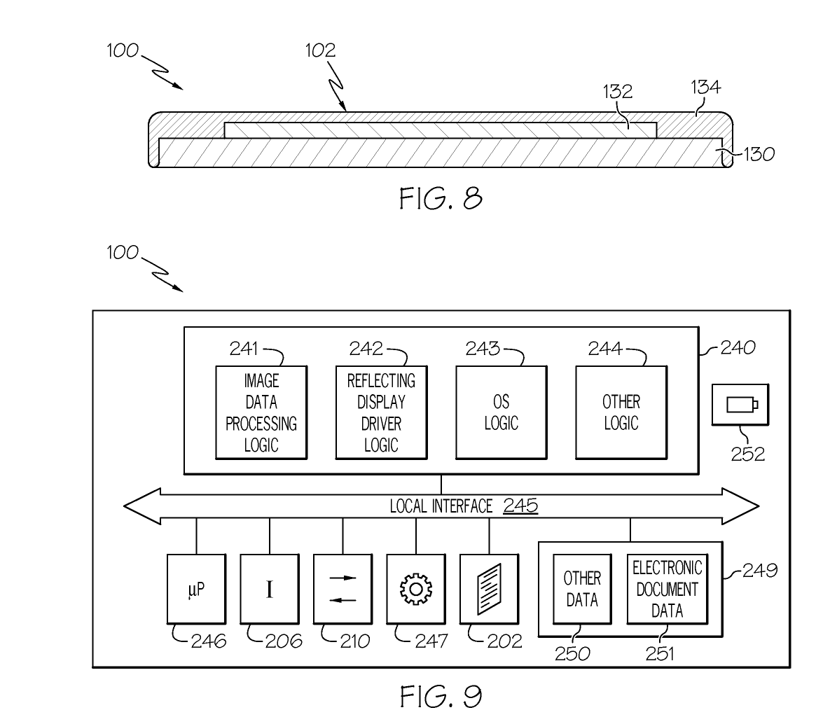

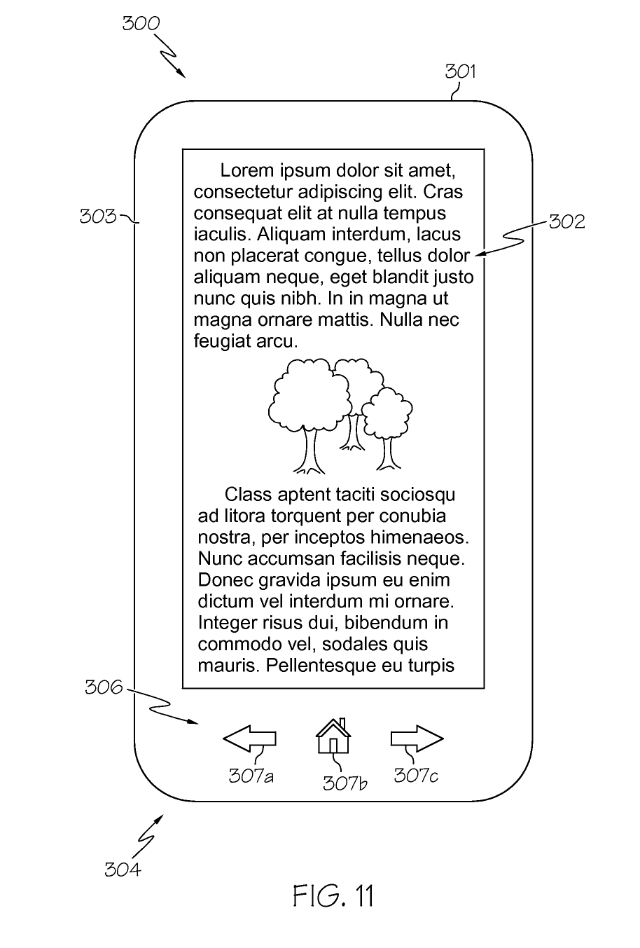

Communication between the electronic display case 100 and the electronic device 120 may be provided by a communication channel configured as a wired connection or by a wireless communication protocol (e.g., Bluetooth, WiFi, and the like). Referring now to FIGS. 3 and 4, an electrical connector 110 that is operable to be mechanically coupled to a communications port of the electronic device 120 is illustrated. Accordingly, display data (as well as other data) may be communicated between the electronic device 120 and the electronic display case 100 via the wired connection between the electrical connector 110 and the communications port of the electronic device 120. Further, the electrical connector 110 may also provide a power connection to the electronic device case 100 to either charge a rechargeable battery within the electronic device case 100 or remotely power the electronic device case 100 (i.e., the electronic device 120 powers the electronic device case 100). As described in more detail with respect to FIGS. 9-11, embodiments may also communicate with the electronic device 120 by wireless communication protocols. Embodiments that utilize a wireless communication protocol may enable a user to view display data from the electronic device 120 on the reflective display 102 of the electronic device case 100 when the electronic device 120 is not physically coupled to the electronic device case 100.

Referring generally to FIGS. 1-4, in the illustrated embodiment, the electronic display case 100 further comprises a control portion 104 that is below the reflective display 102. The control portion 104 may include a user input device 106. In the illustrated embodiment, the user input device 106 is configured as several user-selectable buttons 107a-107d so that a user may provide input to the electronic display case 100, such as, in an e-book application, turn the page forward, turn the page backward, go to a menu, navigate a menu, send data to the electronic device 120, and the like. In other embodiments, the user input device 106 may be defined by a touch sensitive layer (e.g., capacitive- or resistive-sensitive layer(s)) on the control portion 104 and/or the reflective display 102. The touch sensitive layer may be configured as any known or yet-to-be developed layer(s) operable to detect physical contact with a user so that the user may provide input to the electronic device case 100 by hand gestures. Other input devices may also be utilized, such as by voice in embodiments that include a microphone. The control portion 104 is positioned below the electronic device 120 that is coupled to the electronic device case 100 in the illustrated embodiment; however, the control portion 104 may not extend below the electronic device 120 in other embodiments. Further, the electronic device case 100 may not include a control portion 104, particularly in embodiments that utilize a touch-sensitive layer on the reflective display 102 for user input functions.

The control portion 104 of the illustrated embodiment further includes an audio connector 112 (e.g., a headphone jack) operable to be coupled to an audio port of the electronic device 120. However, the audio connector 112 may not be provided in alternative embodiments. The audio connector 112 may also have a receptacle opening 113 (FIG. 3) on a bottom wall 115b of the case body 113 to allow a headphone jack of a user's headphones or other audio equipment to be inserted into receptacle opening 113 and provided to the electronic device 120 via the audio connector 112 that is coupled to the audio port of the electronic device 120. In addition to audio signals, the audio connector 112 may be configured to receive electrical power from the audio port of the electronic device 120 if the electronic device 120 is configured to provide such power capabilities. In other embodiments, an opening is provided in place of the audio connector to provide access to the audio port of the electronic device 120.

It should be understood that embodiments are not limited to the means for communicatively coupling the electronic device case 100 to the electronic device 120 as there is a wide variety of communication port configurations amongst the plethora of electronic devices on the market.

The control portion 104 may also maintain electronic components of the electronic device case 100. For example, one or more processors, data storage components, reflective display drivers, and other active and/or passive electronic components necessary to display content on the reflective display 102 may be maintained within the control portion 104. In other embodiments, such electronic components are maintained within other regions of the electronic device case (e.g., within one or more of the side walls 115a-115d and/or the rear surface 103.)

Referring specifically now to FIGS. 3 and 4, a rear side of the exemplary electronic device case 100 is illustrated. The rear side is the side of the electronic device case 100 that the electronic device 120 is inserted by the user. For example, referring to FIG. 4, the user may position the electronic device 120 within an opening 117 of the electronic device case defined by the plurality of side walls 115a-115d and the rear surface 103 and plug the communications port and audio port (not shown) of the electronic device 120 into the electrical connector 110 and the audio connector 112 of the electronic device case 100.

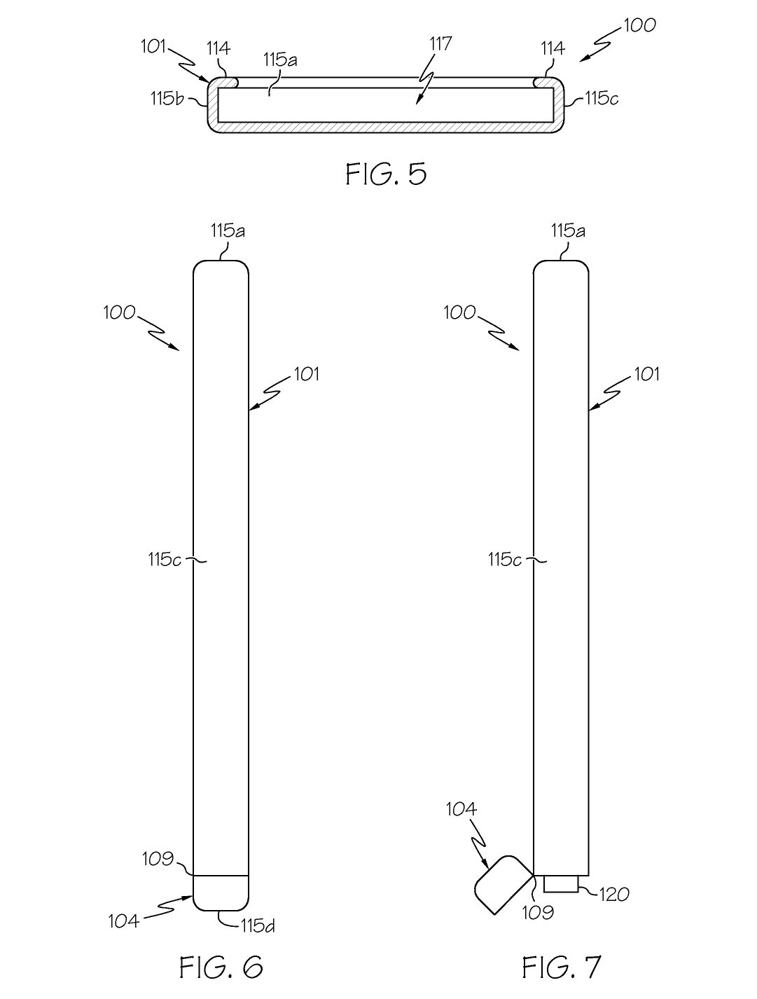

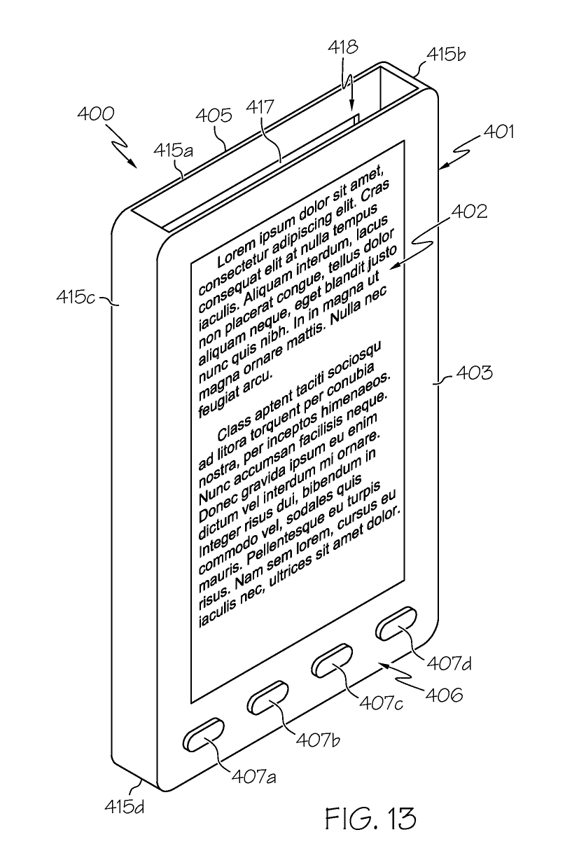

As stated above, the case body 101 includes a plurality of side walls 115a-115d that surround the edges of the electronic device. The side walls 115a-115d have an engagement feature 114 that engages the electronic device 120 such that the electronic device case 100 may be removably coupled to the electronic device 120. The engagement features 114 of the illustrated embodiment are configured as a lip 114 that are generally perpendicular to the side walls 115a-115d. For example, the lip 114, as well as the side walls 115a-115d, may be pliable to be bent away from the electronic device 120 during insertion, and then conform to the shape of the edges of the electronic device 120. In the illustrated embodiment, the engagement feature 114 comprises a pliable lip that may be deformed to insert the electronic device into the electronic device case 100. FIG. 5 is a cross-sectional view of the electronic device case 100 illustrated in FIG. 4 taken along line 5-5. The pliable lips 114 and side walls 115a-115d contact the edges and front surface of an electronic device 120. Accordingly, the side walls 115a-115d of the electronic device case 100 may fully surround the edges of the electronic device 120. Embodiments may utilize engagement features other than the pliable lips depicted in FIGS. 4 and 5, such as an adhesive that allows a user to adhere the electronic display case 100 to the electronic device 120. Other engagement configurations may be used, as described below with respect to FIGS. 13-18. Further, mechanical clips may be used to removably couple the electronic device case 100 to the electronic device 120.

As shown in FIG. 3, when the electronic device 120 is inserted into the opening 117 and is removably coupled to the electronic device case 100, a native illuminated display 122 of the electronic device 120 is visible to the user. Accordingly, the electronic device cases described herein transform the electronic device 120 from a single, backlit screen device to a dual screen display device, wherein the native illuminated display 122 of the electronic device 120 is backlit and the reflective display 102 of the electronic device case 100 is reflective.

FIGS. 6 and 7 depict a side view of an exemplary electronic device case 100 comprising a hinge portion 109 that rotatably couples the control portion 104 to the remaining case body 101. FIG. 6 shown the control portion 104 in a closed portion with respect to the case body 101, while FIG. 7 shows the control portion 104 rotated about the hinge portion 109 in an opened position with respect to the case body 101. Opening the control portion 104 may expose the electronic device 120. For example, opening the control portion 104 about the hinge portion 109 may provide access to the communications port of the electronic device 120. A user may wish to open the control portion 104 to plug the electronic device 120 into a cable, such as a communications or charging cable. Closing the control portion 104 about the hinge allows the electrical connector 110 and the audio connector 112 (if present) to be communicatively coupled to the communications port and the audio port of the electronic device 120, respectively.

In other embodiments, the electrical connector 110 (as well as the audio connector 112) figured as a pass through connector to allow a cable to be inserted into the electronic device case 100 and electrically coupled to the electronic device 120 without requiring the user to physically access the communications port or audio port of the electronic device, such as by removing the electronic device 120 from the electronic device case 100 or pivoting a control portion 104 as depicted in FIGS. 6 and 7.

Rather than a rigid electrical connector 110, a wired communication link between the electronic device case 100 and the electronic device 120 may be provided by a flexible connector (e.g., a flex circuit that is configured to be coupled to the communications port of the electronic device 120).

Thus, a user may attach the electronic device case 100 to an electronic device 120, such as a smart phone or other mobile electronic device. The reflective display 102 is present on a backside of the electronic device 120, and opposes the illuminated display 122 of the electronic device 120. The electronic device case 100 is communicatively coupled to the electronic device 120, either by a wired connection or wirelessly, as described above. In some embodiments, one or more applications stored and operated by the electronic device 120 may be configured to send display content to the reflective display 102 of the electronic device case 100.

In some embodiments, the user may instruct the electronic device 120 to send display content to the reflective display 102 by selection of one or more icons or options provided by the illuminated display 122 of the electronic device 120. In other embodiments, the electronic device 120 may send display content to the reflective display 102 in response to an input received from the user interface 106 of the electronic device case 100. Further, in other embodiments, a motion sensor of the electronic device 120 (e.g., an accelerometer, a gyroscope, a magnetometer, or combinations thereof) may detect a rotation of the electronic device 120 from a position wherein the illuminated display 122 faces the user to a position wherein the illuminated display 122 faces away from the user. Upon detection of such a rotation, the electronic device 120 may send display content to the reflective display 102, and turn off or otherwise disable the illuminated display 122. Similarly, rotation of the electronic device 120 back to a position such that the illuminated display 122 faces the user may cause the illuminated display 122 to be illuminated once again.

As an example and not a limitation, the user may select an e-book reader application (or any other application or program) stored on the electronic device 120 by selecting an icon on the illuminated display 122 (or otherwise selecting the e-book reader application). Selecting the e-book reader application causes the processor or processors of the electronic device 120 to execute the e-book reader application and display information relating thereto via a user interface on the illuminated display. The user interface may have an option to send the display visual information or content to the reflective display 102 of the electronic device case 100. In some embodiments, when the user selects the option to send the display content to the reflective display 102, the illuminated display of the electronic device 120 is disabled (i.e., turned off), and display data corresponding to display information or content originally intended for the illuminated display is sent to the electronic device case 100, where it is then displayed on the reflective display 102. Significant battery savings may be realized by disabling the illuminated display of the electronic device 120 while displaying the display content on the reflective display 102. However, in some embodiments, both the illuminated display and the reflective display 102 may display content simultaneously. Further, only the light source of the illuminated display may be disabled when content is displayed on the reflective display 102 such that content may be still visible on the illuminated display, although dimmed. Embodiments may provide the user to select any of the above options.

The user may then interact with the e-book via the electronic device case 100 rather than the electronic device 120. For example, the user may make menu selections, change pages, change font sizes, switch files (e.g., books) from the control portion 104. It is noted that in some embodiments, the display data originates from the electronic device 120, and, therefore, minimal memory is required to be included in the electronic device case 100. However, in some embodiments, the electronic device case 100 has memory capable of storing display data (e.g., in the form of e-book files) that may be accesses and displayed on the reflective display 102.

In some embodiments, the user is able to use the graphical user interface of the operating system running on the electronic device 120 to switch between applications (e.g., between an e-book reader and an e-mail client), or access data stored locally on the electronic device 120, using the electronic device case 100. For example, the user may be able to perform any task using the electronic device 120 that is capable of being performed using the illuminated display of the electronic device 120. In other embodiments, the user may be able to only use the electronic device case 100 to view information or perform tasks for certain applications.

When the user is finished with reading his or her e-book (or other information relating to other applications), he or she may select to display the information or content on the illuminated display once again. As non-limiting examples, the control portion 104 may provide the option of turning on the illuminated display and cease sending display information to the control portion 104, the user may select a “home” button or other button on the electronic device 120 to display content on the illuminated display, or by other means.

Further, in some embodiments, the reflective display 102 may display decorative designs according to user-preference so that the user may personalize his or her electronic case. The reflective display 102 may also display other information when not actively used, such as the weather, the time, message indicators, calendar events, and the like.

Additional exemplary hardware components of exemplary electronic device case 100 will now be described in detail. FIG. 8 depicts a partial cross-sectional view of a reflective display 102 of an electronic device. It should be understood that the reflective display 102 depicted in FIG. 8 is for illustrative purposes only, and the reflective displays of other embodiments may have more or fewer components, as well as components arranged in other configurations. The flexible display generally comprises an electronic ink layer 132 disposed on a substrate 130. The electronic ink layer 132 is the active layer comprising an array of bi-stable pixels. The electronic ink layer 132 may be configured as any known or yet-to-be-developed bi-stable display, such as electrophoretic, electrowetting, cholesteric liquid crystal, and the like. In embodiments providing a flexible electronic device case, the substrate 130 may be configured as any suitably flexible or pliable material, such as plastic, for example. In other embodiments not providing a flexible electronic device case, or an electronic device case that is flexible except for the reflective display portion, the substrate may be of a rigid material, such as glass, rigid plastic, composite materials, FR-4, and the like.

In some embodiments, the electronic ink layer 132 and the substrate 130 may be covered with an overmold layer 134 to protect the electronic ink layer 132. For example, the overmold layer 134 may be substantially transparent to allow a user to view the display information or content provided by the electronic ink layer 132. The overmold layer 134 may also be configured as a unitary component with the remainder of the material used to fabricate the side walls 115a-115d and other components of the electronic device case 100. For example, the electronic ink layer 132 and the substrate 130 may be overmolded with the remaining material of the electronic device case 100. In other embodiments, the molded material of the electronic device case 100 acts as the substrate 130 such that the electronic ink layer 132 is deposited on the a surface electronic device case 100 and the overmold layer 134 is then applied to the electronic ink layer 132.

Additional layers may also be utilized. For example, one or more scratch resistance layers, smudge resistance layers, texture layers, touch-sensitive layers, and the like, may be applied to the overmold layer for additional functionality. The flexible nature of the reflective display 102 makes it impact resistant, and it, along with the remaining portions of the electronic device case 100, will act to protect the electronic device 120.

FIG. 9 depicts exemplary software, hardware and/or firmware components of an electronic device case 100 as described herein. FIG. 9 further illustrates a system and/or a non-transitory computer usable medium having computer readable program code for receiving display data from an electronic device and displaying information or content on a reflective display of an electronic device case embodied as hardware, software, and/or firmware, according to embodiments shown and described herein.

The electronic device case 100 may include one or more processors 246, input hardware 206, device interface hardware 210 (i.e., a communications module), a data storage component 249 (which may store electronic document data 251 either received from the electronic device or another source, and other data 250 that may be necessary to receive and display content on the reflective display or information such as user preferences, screen saver displays, and the like) and a non-transitory memory component 240. The non-transitory memory component 240 may be configured as volatile and/or nonvolatile computer readable medium and, as such, may include random access memory (including static random-access memory, dynamic random-access memory, synchronous dynamic random-access memory) and/or other types of random access memory), flash memory, registers, and/or other types of storage components. Additionally, the non-transitory memory component 240 may be configured to store logic, such as, for example, image data processing logic 241, reflective display driver logic 242, operating system logic 243, and other logic 244 (each of which may be embodied as computer readable program code, firmware, or hardware, as an example). A local interface 245 is also depicted in FIG. 9, and may be implemented as a bus or other communication interface (either wired or wireless) to facilitate communication among the components of the electronic device case 100.

The processor 246 (or processors) may include any processing component configured to receive and execute computer readable code instructions (such as those stored on the data storage component 249 and/or non-transitory memory component 240). The input hardware 206 may include any hardware configured to enable a user to interact with the reflective display 202, such as the buttons 107a-107d of the control portion 104 described above with respect to FIG. 1, or a touch-screen layer on the reflective display 102/202, as also described above. The input hardware 206 may also include hardware, software, and/or firmware that is configured to communicate with an external input device, such as a keyboard, a mouse, a camera, a microphone, and/or other device for receiving input from a user.

The device interface hardware 210 may include any hardware capable of establishing a communication link for communicating data, such as display data, between the electronic device case 100 and an electronic device to which the electronic device case 100 is coupled. In some embodiments, the device interface hardware 210 is a component of the control portion 104 described above, and allows for the electronic device case 100 to send and receive data. For example, the electrical connector 110 depicted in FIGS. 3 and 4 may be a component of the device interface hardware 210, which further include hardware, software and/or firmware to facilitate communication between the electronic device case 100 and an electronic device. In other embodiments, the device interface hardware 210 includes a wireless communications module such that the electronic device case 100 may communicate data wirelessly with the electronic device. As an example and not a limitation, the device interface hardware 210 may be configured to communicate with the electronic device via the Bluetooth® communication protocol. It should be understood that other wireless communication protocols may be utilized.

In some embodiments, the device interface hardware 210 may also include any wired or wireless networking hardware, such as a modem, LAN port, wireless fidelity (Wi-Fi) card, WiMax card, mobile communications hardware, and/or other hardware for communicating with other networks and/or devices other than the electronic devices described herein. For example, the device interface hardware 210 may enable the electronic device case 100 to access the Internet so that content may be downloaded directly to the electronic device case 100 without the need for the electronic device case 100 to be coupled to the electronic device.

The exemplary electronic case 100 further includes a reflective display driver 247 and a reflective display 202. The reflective display 202 may be a reflective display as described above. The reflective display driver 247 may be configured as any hardware components capable of sending signals to the reflective display 202 to cause the reflective display 202 to display the desired content. For example, the reflective display driver 247 may address the individual pixels by sending voltages to turn the pixels “ON” or “OFF” according to the display data. The reflective display driver 247 may receive display data from the electronic document data 239, which may be processed according image data processing logic 241 and/or reflective display driver logic, as described in detail below.

It should be understood that the data storage component 249 may be configured to store one or more pieces of data for access by the electronic device case 100. It should also be understood that the data storage component 249 and the non-transitory memory component 240 may be configured as a single memory component. As illustrated in FIG. 9, the data storage component 249 may store electronic document data 251, which in at least one embodiment includes display data related to documents or other files received from the electronic device via the device interface hardware 210 (or from other sources). The electronic document data 251 may include data relating to any type of file for display on the reflective display 202, such as e-book document files, HTML files, word-processing document files, e-mail client files, etc. Other data 250 may also be stored in the data storage component 249 to provide support for functionalities described herein.

Included in the non-transitory memory component 240 may be the image data processing logic 241, the reflective display driver logic 242, operating system logic 243, and other logic 244. The operating system logic 243 may include an operating system and/or other software for managing components of the electronic device case 100. The image data processing logic 241 may act as a driver module that is provided to format the electronic document data (e.g., electronic document data received from the electronic device) into converted display data that is in a format capable of being read and executed by the reflective display driver 247. For example, the electronic device may provide electronic document data (or other data representing display content to be displayed) in a first format, and the image data processing logic may convert the electronic document data into a second format that is capable of being read by the reflective display driver 247. In other embodiments, the electronic device may communicate the electronic document data to the electronic device case 100 in a format that is readable by the reflective display driver 247 such that the electronic device case 100 does not need to format the display data.

The reflective display driver logic 242 may be any computer readable instructions that may be needed for the reflective display driver 247 to generate the voltages to control the reflective display 202. In some embodiments, reflective display driver 247 may not utilize reflective display driver logic and may be configured as only hardware. It should be understood that the reflective display driver logic 242 may be stored on the reflective display driver 247 rather than in the non-transitory memory component 240.

Other logic 244 may be configured as computer readable instructions that are configured to perform miscellaneous functions. It should be understood that the components illustrated in FIG. 9 are merely exemplary and are not intended to limit the scope of this disclosure. Other configurations are also possible.

In some embodiments, the electronic device case 100 further includes a power supply, such as a battery 252. The battery 252 may be configured as a rechargeable battery that may by charged by an electrical connection to the electronic device, and or by an electrical connection to another power source, such as the electric grid. In other embodiments, the electronic device case 100 does not include a battery but rather receives electrical power directly from the electronic device.

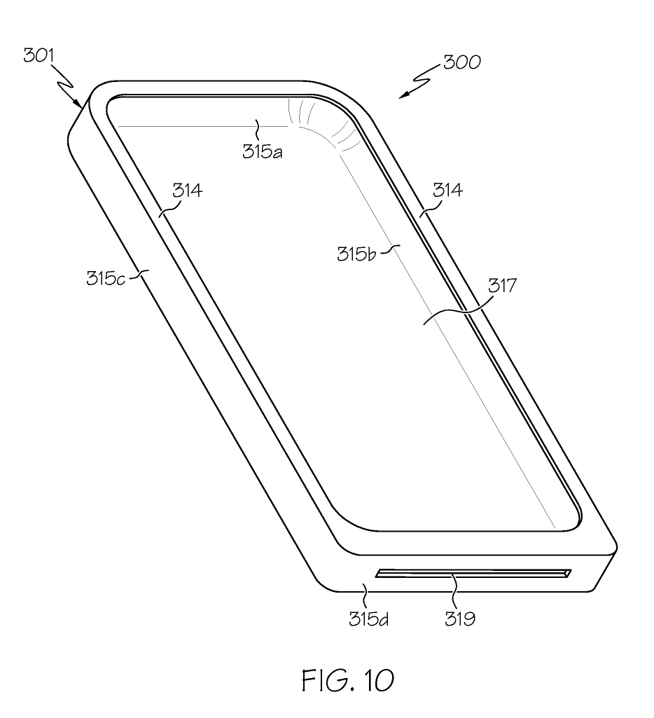

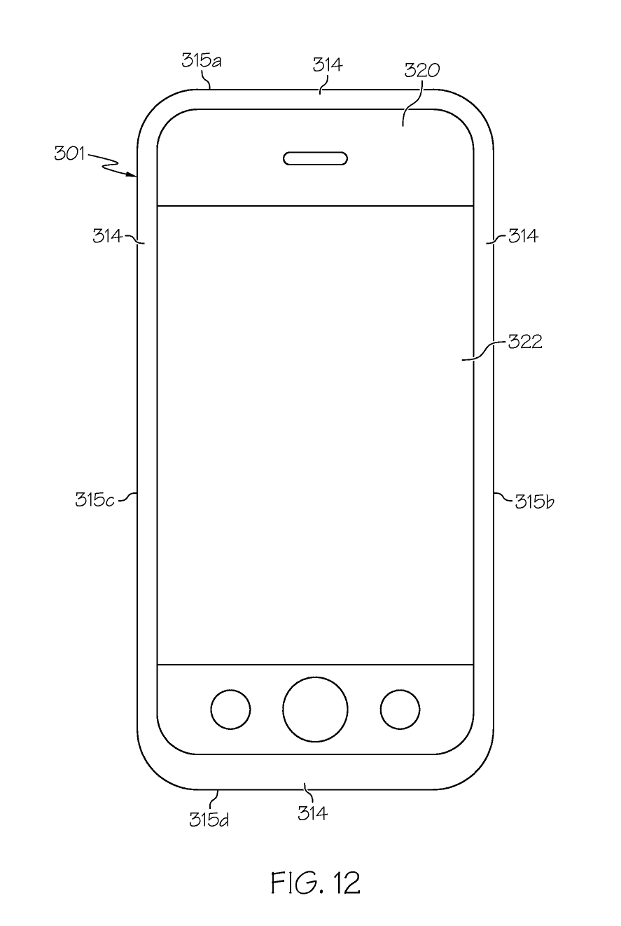

Referring now to FIGS. 10-12, another exemplary electronic device case 300 is illustrated. The electronic device case 300 generally comprises a case body 301 that is configured to be removably coupled to the electronic device 320. The case body 301 generally includes a rear surface 303 and a plurality of side walls 315a-315d that may surround a plurality of edges of the electronic device 320. The side walls 315a-315d define a lip 314 that acts as an engagement feature that enables the electronic device case 300 to be removably coupled to the electronic device 320. In some embodiments, the case body 301 may be fabricated from a pliable material, such as silicone, for example, so that the case body 301 may be stretched and conform to the shape of the electronic device 320 is coupled. In other embodiments, the case body 301 may be fabricated from a more rigid material, such as rigid plastic. The plurality of side walls 315a-315d define an opening 317 into which the electronic device 320 may be positioned such that the plurality of side walls 315a-315d and the lip 314 wrap around and engage the edges of the electronic device 320.

As described above with respect to FIGS. 1 and 2, the electronic device case 300 further comprises a reflective display 302 within the rear surface 303 of the case body 301. The reflective display 302 is present on a backside of the electronic device 320 when the electronic device case 300 is coupled to the electronic device 320. The reflective display 302 may be configured as any type of display that does not require backlighting to be viewable by a user, as described above.

Communication between the electronic device case 300 and the electronic device 320 of the illustrated embodiment is provided by wireless communication. For example, the electronic device case 300 may communicate with the electronic device 320 by a wireless communication protocol (e.g., Bluetooth, WiFi, and the like), as described above. The internal components, such as a wireless communication module and other components such as those depicted in FIG. 9, may be maintained within the case body 301. For example, these internal components may be disposed below and/or behind the reflective display 302. The illustrated embodiment further includes a communications port opening 319 configured to accept a communications connector so that the user may pass the communications connector through the communications port opening 319 and directly into a communications port of the electronic device 320.

The electronic display case 300 of the illustrated embodiment further comprises a control portion 304 that is below the reflective display 302. The control portion 304 includes a user input device 306. In the illustrated embodiment, the user input device 306 is configured as several user-selectable buttons 307a-107c so that a user may provide input to the electronic display case 300, such as, in an e-book application, turn the page forward (e.g., forward arrow button 307c), turn the page backward (e.g., backward arrow button 307a), go to a menu (e.g., home button 307b), send data to the electronic device 320, and the like. In other embodiments, the user input device 306 may be defined by a touch sensitive layer (e.g., capacitive- or resistive-sensitive layer(s)) on the control portion 304 and/or the reflective display 302. Other input devices may also be utilized, such as by voice in embodiments that include a microphone, as described above. The control portion 304 is positioned below the electronic device 320 that is coupled to the electronic device case 300 in the illustrated embodiment; however, the control portion 304 may not extend below the electronic device 320 in other embodiments. Further, the electronic device case 300 may not include a control portion 304, particularly in embodiments that utilize a touch-sensitive layer on the reflective display 302 for user input functions.

Referring now to FIG. 13, an exemplary electronic device case 400 configured as a sleeve for an electronic device is illustrated. It is noted that the electronic device is not depicted in FIG. 13. The electronic device case 400 comprises a case body 401 having a plurality of side walls 415a-415d, a rear surface 403, and a front surface 405 that define an opening 418 at a top side wall 415a. The electronic device 420 may be inserted into the electronic device case 400 may inserting a bottom of the electronic device 420 into the opening and sliding the electronic device fully into the electronic device case 400. The front surface 405 contacts a front surface of the electronic device 420, and includes a display opening 417 that exposes the illuminated display of the electronic device 420.

The rear surface 403 of the case body 401 includes a reflective display 402, which may receive and display content from the electronic device, as described above. The electronic device case 400 depicted in FIG. 13 may be communicatively coupled to the electronic device by a wired connection, such as by an electrical connector 110 similar to that depicted in FIG. 4, or by a wireless communication protocol. The illustrated electronic device case 400 includes control portion providing a user interface 406 comprising a plurality of user-selectable buttons 407a-407d. As described above, the user interface 406 may also be provided by a touch-sensitive layer, or by user-selectable buttons 407a-407b arranged in a configuration other than the configuration depicted in FIG. 13.

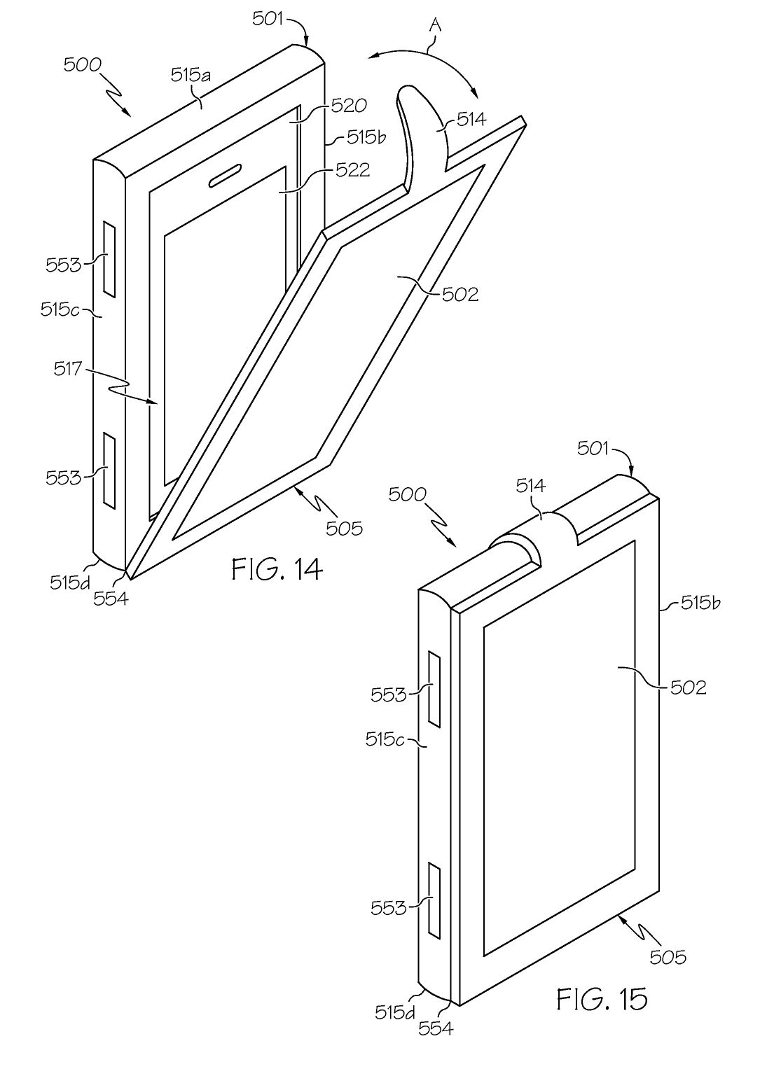

FIGS. 14 and 15 illustrate another exemplary electronic device case 500. The electronic device case 500 depicted in FIGS. 14 and 15 has a cover flap 505 including a reflective display 502 extending from a bottom side wall 515d. Generally, the electronic device case 500 includes a case body 501 having a plurality of side walls 515a-515d that define an opening 517 into which an electronic device 520 having an illuminated display 522 may be disposed. The side walls 515a-515d may engage the electronic device 520 in some embodiments (e.g., by a lip engaging feature as described above). One or more of the side walls 515a-515d may also include openings 553 for access to one or more buttons of the electronic device 520.

The case body further includes a cover flap 505 extending from a bottom side wall 515d such that a hinge portion 554 is defined between the bottom side wall 515d and the cover flap 505. The reflective display 502 is located at an outer surface of the cover flap 505. The cover flap 505 may be rotated about the hinge portion 554 to cover and uncover the electronic device 520, as shown by arrow A. FIG. 14 shows the electronic device case 500 in a slightly open position, while FIG. 15 shows the electronic device case 500 in a closed position. The cover flap 505 of the illustrated embodiment further includes an engagement feature 514 that is configured to be connected to a top portion of the case body 501, such as the top side wall 515a. For example, the engagement feature 514 may include a flexible tab having a mechanical snap or Velcro to close the cover flap 505 at the top side wall 515a. The cover flap 505 may also be magnetically maintained in a closed position in some embodiments. In some embodiments, there is no flexible tab. The electronic device case 500 may also include a user interface as described above.

The illustrated electronic case 500 may be fabricated from one or more materials. In one non-limiting example, a majority of the case body 501 is fabricated from leather. For example, the reflective display 502 may be maintained within a leather cover flap. Other materials may also be used, such as silicone and polyimide materials, as described above.

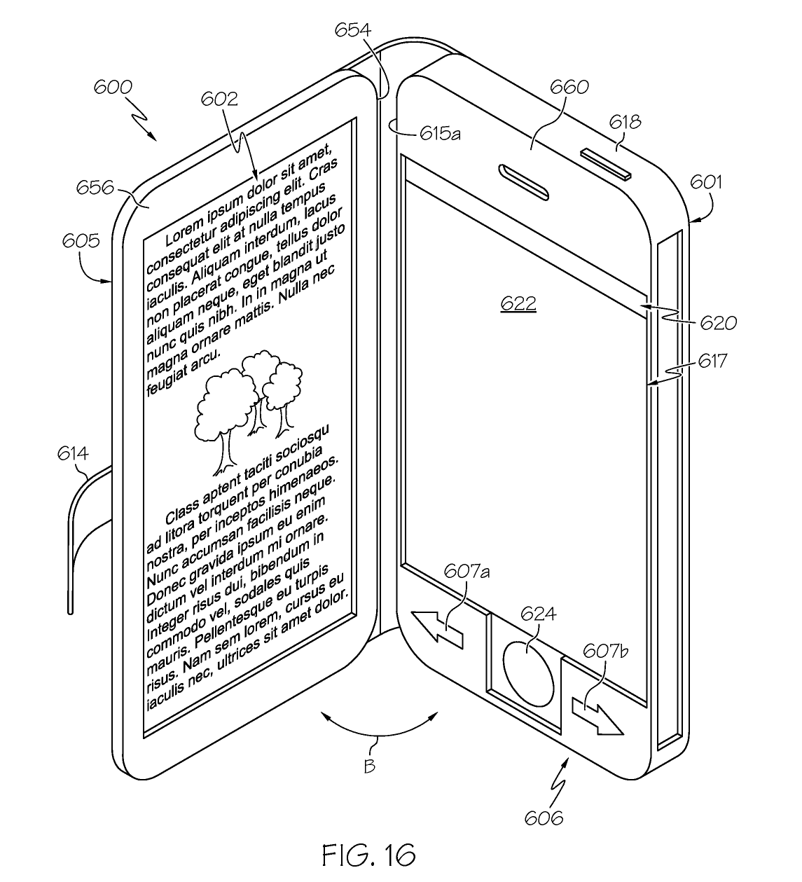

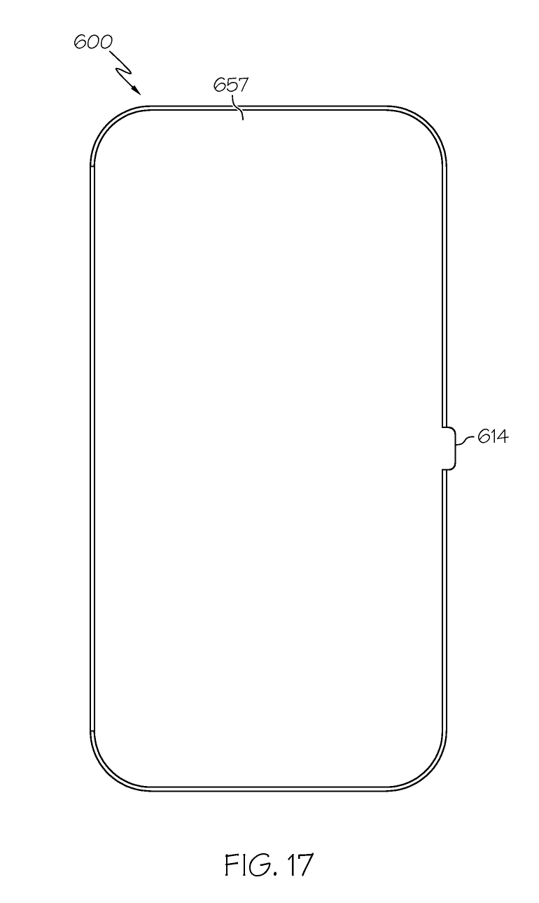

FIGS. 16 and 17 depict another embodiment wherein the electronic device case 600 includes a cover flap 505. As described below, the cover flap 505 of this embodiment allows the electronic device case 600 to be opened and read like a traditional book. The electronic device case 600 includes a case body 601 that surrounds an electronic device 620 such that an illuminated display 622 is exposed by an opening 617 in the case body 601. The electronic device case 600 further includes a cover flap 605 extending from a left (or right) side wall 615a, thereby defining a hinge portion 654 between the cover flap 605 and the left side wall 615a. A reflective display 602 is disposed within an inner surface 656 of the cover flap 605 to display content to the user. The cover flap 605 may be opened and closed by rotating it about the hinge portion 654 as depicted by arrow B. An engagement feature 614 may be provided to maintain the electronic device case 600 in a closed orientation. The engagement feature 614 may be configured as described above with respect to the engagement feature 514 depicted in FIGS. 14 and 15 (e.g., snaps, Velcro, magnets, etc.). Any engagement arrangement may be used.

The case body 601 may also expose one or more user interface buttons 624 or controls of the electronic device 620 for access to the user. In the illustrated embodiment, an inner surface 660 of the case body 601 includes a reflective display user interface 606 (e.g., user selectable buttons 607a-607b) that is operable to control what is displayed on the reflective display, as described above. In other embodiments, the user interface may be provided on the inner surface 656 of the cover flap 605 instead of, or in addition to, the inner surface 660 of the case body 601.

FIG. 16 depicts the electronic device case 600 in an opened position, while FIG. 17 depicts the electronic device case 600 in a closed position. The user may open the cover flap 605 and read the reflective display 602 like a book. In some embodiments, content may be displayed on both the reflective display 602 and the illuminated display 626 of the electronic device 620. For example, the illuminated display 626 may display supplementary content while the reflective display 602 may display primary content. As an example and not a limitation, using an e-book reader as an example, the reflective display 602 may display a page of the e-book, while the illuminated display 626 of the electronic device 620 may display menu information, table of contents information, author, chapter information, or any other type of information relating to the particular e-book that the user is reading. The illuminated display 626 may also display information unrelated to the content that the user is reading. For example the illuminated display 626 may display information relating to other applications running on the electronic device 620, such as an e-mail client as a non-limiting example. In some embodiments, the reflective display 602 may display a left-hand page of an e-book, while the illuminated display 626 may display a right-hand page of the e-book.

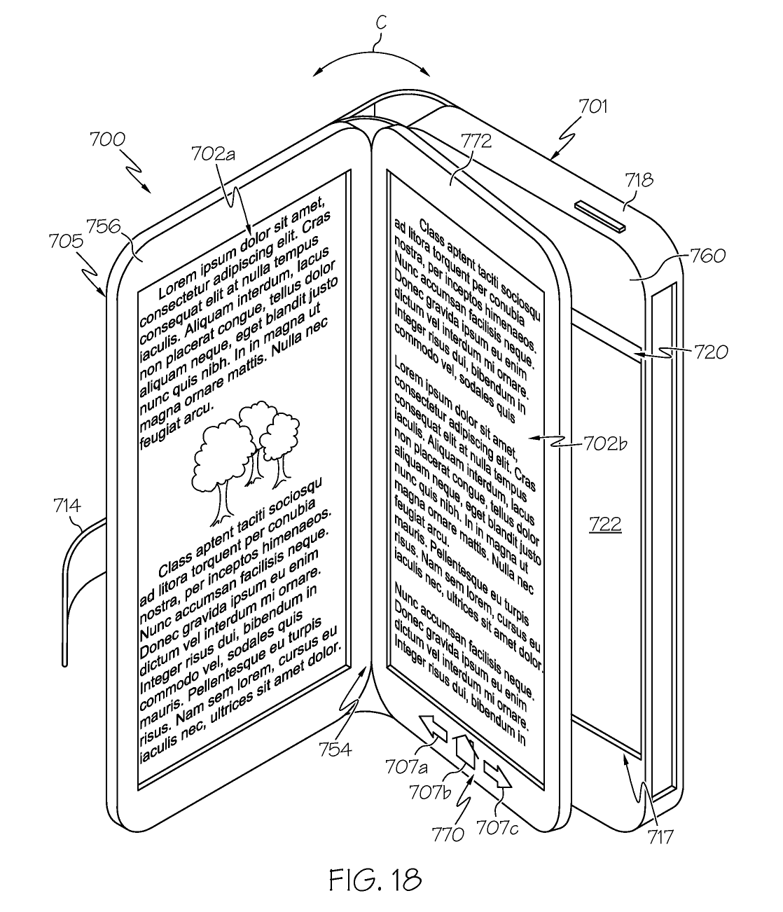

Referring now to FIG. 18, another exemplary embodiment of an electronic device case 700 is depicted. The electronic device case 700 includes a case body 701 that surrounds an electronic device 720 such that an illuminated display 722 is exposed by an opening 717 within an inner surface 760 of the case body 701. The electronic device case 700 further includes an outer cover flap 705 and an inner cover flap 770. A first reflective display 702a is provided at an inner surface 756 of the outer cover flap 705, and a second reflective display 702b is provided at a surface 772 of the inner cover flap 770. The first and second reflective displays 702a, 702b may be coupled to one or more display drivers within the electronic device case 700, and receive display data from the electronic device 720. One or more user selectable buttons 707a-707c may be provided at any location on the electronic device case 700 to allow the user to control what content is displayed on the first and/or second reflective display 702a, 702b.

The outer cover flap 705 and the inner cover flap 770 may be moved between an opened and a closed orientation by rotation about a hinge portion 754 as depicted by arrow C. An engagement feature 714 may be provided to maintain the electronic device case 700 in a closed orientation. The engagement feature may be configured as described above with respect to the engagement feature 614 depicted in FIGS. 16 and 17 (e.g., snaps, Velcro, magnets, etc.).

The first and second reflective displays 702a, 702b of the outer cover flap 705 and the inner cover flap 770 may allow the electronic device case 700 to be opened and read like a traditional book. As an example and not a limitation, the electronic device 720 may provide display data corresponding to an e-book to the first and second reflective displays 702a, 702b. The first reflective display 702a may display content corresponding to a left-hand page of the e-book, while the second reflective display 702b may display content corresponding to a right-hand page of the e-book. It should be understood that the first reflective display 702a and the second reflective display 702b may display content other than e-book content, as described above.

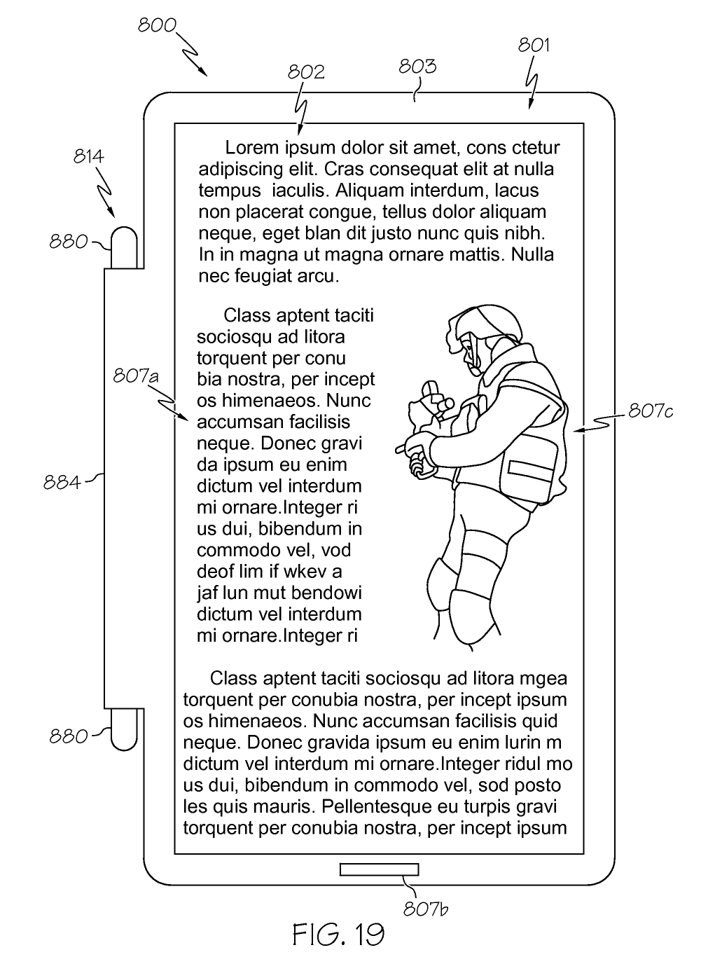

Embodiments of the present disclosure are also directed to electronic device covers in addition to electronic device cases. Electronic device covers are components that are configured to cover the illuminated display of the electronic device. FIGS. 19-21 depict an electronic device cover 800 that is configured to be coupled to an edge 826 of an electronic device 820. As an example and not a limitation, the electronic device 820 may be a tablet computer. The electronic device cover 800 is configured as a cover flap 801 having an inner surface 805 and an outer surface 803. The outer surface 803 may include a reflective display 802 that receives data from the electronic device 820, by a wireless and/or wired connection, as described above. In some embodiments, the cover flap 801 is a flexible flap. In other embodiments, the cover flap 801 is rigid.

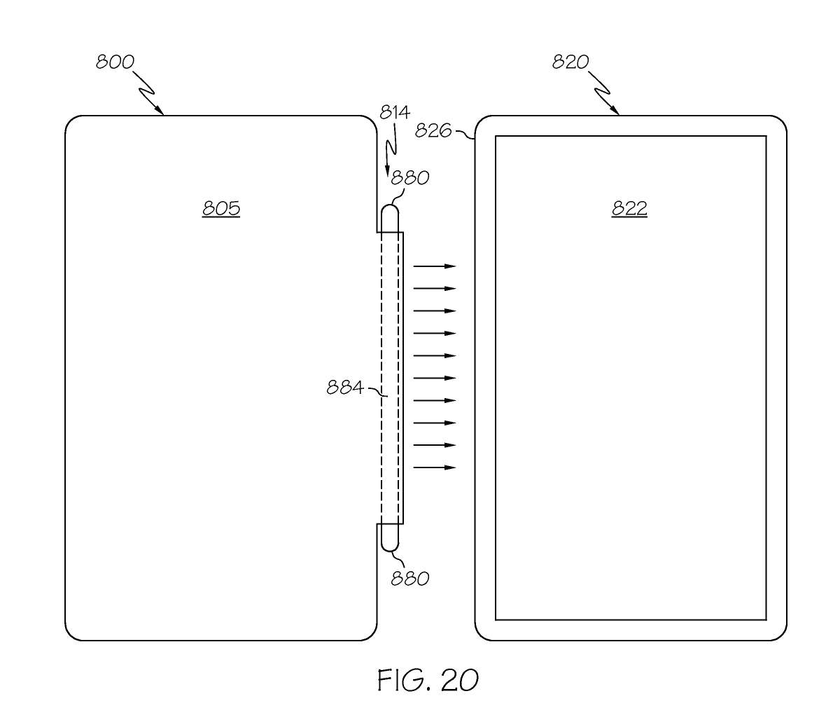

The electronic device cover 800 may be removably coupled to an edge 826 of the electronic device 820 at a hinge portion 814. In the illustrated embodiment, the hinge portion 814 comprises a rigid member 880 that is disposed within an engagement portion 884 of the cover flap 801. As an example and not a limitation, the engagement portion 884 of the cover flap 801 may be configured as a loop through which the rigid member 880 is disposed. The electronic device cover 800 may be removably coupled to the edge 826 of the electronic device by any appropriate coupling means. For example, as shown in FIG. 20, the hinge portion 814 may be magnetically attracted to the edge 826 of the electronic device 820 (as indicated by the horizontal arrows). Once coupled to the edge 826, the electronic device cover 800 may be opened and closed as indicated by arrow D to reveal and conceal the illuminated display 822. The inner surface 805 of the cover flap 801 may have a felt material (or other) to prevent scratches from forming on the illuminated display, in some embodiments.

The outer surface 803 of the cover flap 801 may also include a user interface configured to enable the user to interact with the reflective display 802, as described above (e.g., turn pages, display menu options, etc.). Referring specifically to FIG. 19, an exemplary user interface is defined by touch-sensitive regions 807a-807c. For example, touch-sensitive region 807a may be used by a user to turn a page of an e-book (or other digital content) backward, while touch sensitive region 807c may be used to turn a page of an e-book (or other digital content) forward. Touch-sensitive region 807b may be used to display a menu, for example. More or fewer touch-sensitive regions may be provided, and the touch-sensitive regions may be positioned at locations other than those shown in FIG. 19. In other embodiments, the user interface may be defined by mechanical buttons rather than touch-sensitive regions, or a combination of touch-sensitive regions and mechanical buttons.

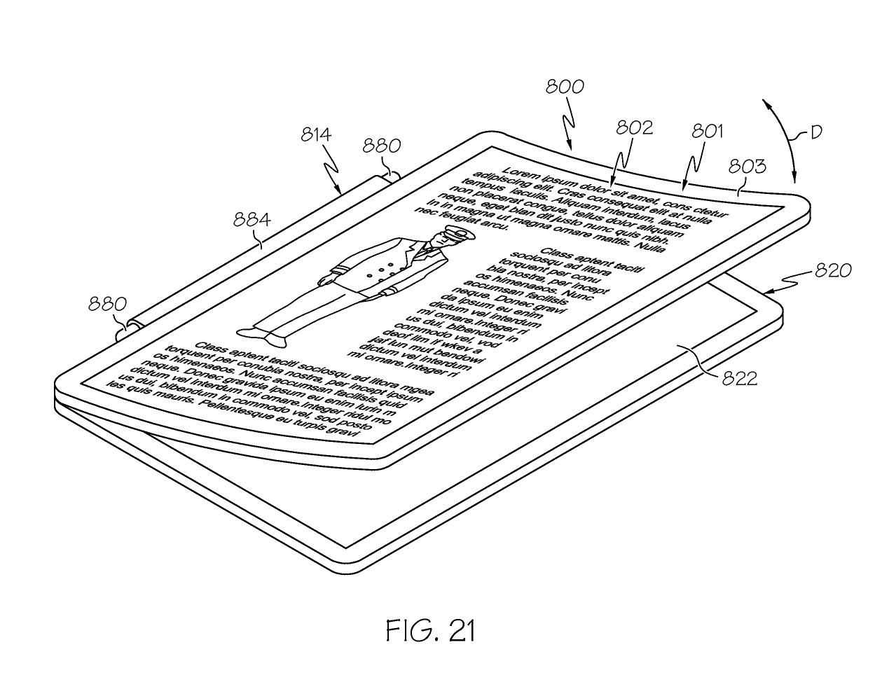

Accordingly, as shown in FIGS. 19 and 21, a user desiring to read or otherwise view the reflective display 802 (e.g., like an e-book reader), may use the illuminated display 822 (or other user input) to instruct the electronic device 820 to output display data to the electronic device cover 800 such that display content is displayed on the reflective display 802. Alternatively, the user may instruct the electronic device 820 to display content on the reflective display 802 using the user interface provided on the outer surface 803 of the cover flap 801 (e.g., touch-sensitive region 807b). The illuminated display 822 may be disabled or otherwise turned off to conserve energy when the reflective display 802 is in use. The user may then close the cover flap 801 such that it covers the illuminated display 822. To turn the illuminated display 822 back on, the user may open the electronic device cover 800 by pivoting it away from the illuminated display 822, in some embodiments. For example, the electronic device 820 may sense that the electronic device cover 800 has been lifted from the illuminated display 822, and it may turn the illuminated display 822 on and clear the display content on the reflective display 802. Optionally, the display content present on the reflective display 802 may be retained upon opening the electronic device cover 800 with respect to the electronic device 820.

It should now be understood that embodiments described herein enable electronic devices having an illuminated display to also include a reflective display. A flexible reflective display within an electronic device case or cover may provide a dual-display device such that a user is not required to carry both an illuminated display device and a reflective display device, such as an e-reader device.

Having described the subject matter of the present disclosure in detail and by reference to specific embodiments thereof, it will be apparent that modifications and variations are possible without departing from the scope of the subject matter defined in the appended claims. More specifically, although some aspects of the present disclosure are identified herein as preferred or particularly advantageous, it is contemplated that the embodiments of the present disclosure are not necessarily limited to these preferred aspects.

What is claimed is:

1. An electronic device case for coupling to an electronic device having an illuminated display, the electronic device case comprising:
a case body configured to surround two or more edges of the electronic device;
a reflective display within the case body, wherein the reflective display is capable of displaying display content, and the reflective display is positioned on a surface of the electronic device that is opposite from the illuminated display of the electronic device when the electronic device case is coupled to the electronic device; and
a reflective display driver within the case body for controlling the reflective display, wherein:
the reflective display driver is electrically coupled to the reflective display and is configured to be communicatively coupled to the electronic device;
the reflective display driver receives display data from the electronic device, the display data corresponding to the display content; and
the reflective display driver controls the reflective display to display the display content corresponding to the display data.

2. The electronic device case as claimed in claim 1, wherein the case body surrounds each edge of the electronic device.

3. The electronic device case as claimed in claim 1, wherein the display data corresponds to content originally intended for display on the illuminated display of the electronic device.

4. The electronic device case as claimed in claim 1, further comprising a user interface configured to receive input from a user of the electronic device case, wherein the input received from the user interface affects the display content displayed by the reflective display.

5. The electronic device case as claimed in claim 1, wherein the case body and the reflective display are flexible.

6. The electronic device case as claimed in claim 1, wherein the reflective display is at least one of: an electrophoretic display, an electrowetting display, an electrofluidic display, and a cholesteric liquid crystal display.

7. The electronic device case as claimed in claim 1, wherein the reflective display is positioned on a surface of the electronic device that is opposite from the illuminated display of the electronic device when the electronic device case is coupled to the electronic device.

8. The electronic device case as claimed in claim 1, wherein the display content for display on the reflective display is a page of an electronic document accessed by the electronic device.

9. The electronic device case as claimed in claim 1, further comprising a rechargeable battery within the case body, the rechargeable battery electrically coupled to at least the reflective display driver.

10. The electronic device case as claimed in claim 1, further comprising a wireless communication module electrically coupled to the reflective display driver and operable to wirelessly communicate with the electronic device such that the display data is wirelessly transmitted from the electronic device to the electronic device case.

11. The electronic device case as claimed in claim 1, further comprising a communications module within the case body for receiving the display data from the electronic device.

12. The electronic device case as claimed in claim 11, wherein the communications module comprises an electrical connector sized to be coupled to a communications port of the electronic device, and the display data is transferred from the electronic device to the communications module via the electrical connector.

13. The electronic device case as claimed in claim 1, further comprising a driver module that receives the display data and converts the display data into converted display data that is in a format that is readable by the reflective display driver, and provides the converted display data to the reflective display driver.

14. The electronic device case as claimed in claim 1, wherein the display data received by the reflective display driver is in a format readable by the reflective display driver.

15. The electronic device case as claimed in claim 1, further comprising a control portion pivotally coupled to the case body, the control portion comprising:
a hinge portion at the case body;
a user interface; and
an electrical connector sized to be coupled to a communications port of the electronic device, wherein the display data is transferred from the electronic device to the reflective display driver through the electrical connector when the control portion is in a closed position, and the control portion is capable of pivoting about the hinge portion to provide access to the communications port of the electronic device.

16. The electronic device case as claimed in claim 1, wherein the case body is a sleeve that is configured to receive the electronic device.

17. An electronic device case for coupling to an electronic device, the electronic device case comprising:
a case body comprising side walls configured surround at least two edges of the electronic device;
a hinge portion at least one of the side walls of the case body;
a cover flap, wherein:
the cover flap is coupled to the hinge portion; and
the cover flap is operable to pivot about an axis defined by the hinge portion to transition between a covered position such that the cover flap substantially covers an illuminated display of the electronic device, and an uncovered position such that the cover flap does not cover the illuminated display of the electronic device;
a reflective display within the cover flap, wherein the reflective display is capable of displaying display content; and
a reflective display driver within the cover flap or the case body, wherein:
the reflective display driver is electrically coupled to the reflective display and is configured to be communicatively coupled to the electronic device;
the reflective display driver receives display data from the electronic device, the display data corresponding to an image for display on the illuminated display of the electronic device; and
the reflective display driver controls the reflective display to display the display content corresponding to the display data.

18. The electronic device case as claimed in claim 17, wherein:
the hinge portion is at a bottom side wall of the case body;
the cover flap comprises an outer surface; and
the reflective display is positioned on the outer surface of the cover flap.

19. The electronic device case as claimed in claim 17, wherein:
the hinge portion is at a left side wall of the case body or a right side wall of the case body;
the cover flap comprises an inner surface; and
the reflective display is positioned on the inner surface of the cover flap.

20. The electronic device case as claimed in claim 19, further comprising an inner cover flap coupled to the hinge portion and disposed between the cover flap and the case body, wherein the inner cover flap comprises a second reflective display.
